(19) United States
(12) Patent Application Publication
(10) Pub. No.: US 2008/0102788 A1
(43) Pub. Date: May 1, 2008

(54) METHOD FOR REPORTING BACK A STATUS OF A MOBILE PHONE AND RELATED MOBILE PHONE

(76) Inventors: Yi-Hsiang Huang, Tao-Yuan Hsien (TW); Yu-Hu Yan, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/924,613

(22) Filed: Oct. 26, 2007

(30) Foreign Application Priority Data
Oct. 27, 2006 (TW) 095139685

(51) Int. Cl. H04M 11/00; H04M 1/00; H04Q 7/22

(52) U.S. Cl. 455/405; 455/412.2; 455/566

(57) ABSTRACT

A method for reporting back a status of a mobile phone includes: (a) a second mobile phone sending a monitoring message to a first mobile phone via a telecommunication system service terminal when the first mobile phone is at a first status; (b) sending a reporting message to the second mobile phone according to the monitoring message when the first mobile phone is at a second status; (c) the second mobile phone comparing data of the monitoring message with data of the reporting message to generate a comparison result after receiving the reporting message; and (d) the second mobile phone displaying an informing frame according to the comparison result.

### BACKGROUND OF THE INVENTION

1. Field of the Invention

The present invention relates to a method for reporting back a status of a mobile phone and a related mobile phone, and more particularly, to a method for reporting back a status of a mobile phone by a message and a related mobile phone.

2. Description of the Prior Art

In highly developed information communication systems in the modern information society, electronic devices are widely utilized in every area. For instance, the utilization of a convenient and lightweight mobile phone device has become a way of communication in our daily life; users can easily exchange and share information, experience, and opinion through the convenience of the mobile phone device. The mobile phone progressed tremendously in recent years and various types of mobile phones are continuously developed. The increasing utilization has created a demand in production, as the mobile phones are becoming common causing the technology of mobile phones to mature with the trend moving towards smaller multi-functional phones. The important issue now is how to design a more convenient mobile phone for the user to utilize.

While the dialed mobile phone does not work, such as being powered off, not receiving signals, being busy, and so on, the user has to try dialing the mobile phone again and again until it works, such as being powered on, receiving signals, not being busy, and so on. It is inconvenient that the user cannot be aware that the mobile phone can be communicated actively.

### SUMMARY OF THE INVENTION

It is therefore a primary objective of the claimed invention to provide a method for reporting back a status of a mobile phone by a message and a related mobile phone for solving the above-mentioned problem.

According to the claimed invention, a method for reporting back a status of a mobile phone includes: (a) a second mobile phone sending a monitoring message to a first mobile phone via a telecommunication system service terminal when the first mobile phone is at a first status; (b) sending a reporting message to the second mobile phone according to the monitoring message when the first mobile phone is at a second status; (c) the second mobile phone comparing data of the monitoring message with data of the reporting message to generate a comparison result after receiving the reporting message; and (d) the second mobile phone displaying an informing frame according to the comparison result.

According to the claimed invention, a mobile phone includes a message editing module for editing a monitoring message, a wireless communication module for sending the monitoring message to a first mobile phone when the first mobile phone is at a first status and for receiving a reporting message when the first mobile phone is at a second status, a storage module for storing a phone number of the first mobile phone when the wireless communication module sends the monitoring message, a comparison means for comparing the phone number of the first mobile phone stored in the storage module with a phone number of the reporting message to generate a comparison result after the wireless communication module receives the reporting message, a display module, and a control means for controlling the display module to display an informing frame according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a telecommunication system according a preferred embodiment of the present invention.

FIG. 2 is a flowchart of reporting a status of a first mobile phone by a message of the present invention.

### DETAILED DESCRIPTION

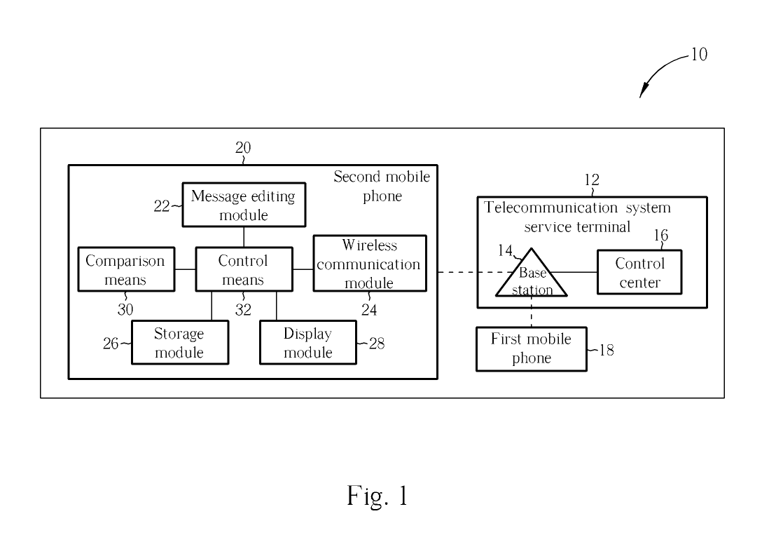

Please refer to FIG. 1 . FIG. 1 is a functional block diagram of a telecommunication system 10 according a preferred embodiment of the present invention. The telecommunication system 10 can be any kind of telecommunication systems for a mobile phone, such as GSM or PHS. The telecommunication system 10 includes a telecommunication system service terminal 12 for providing a telecom service for clients. The telecommunication system service terminal 12 includes a base station 14 for transmitting and receiving radio signals, and a control center 16 for controlling the telecommunication system service terminal 12. The telecommunication system 10 further includes a first mobile phone 18 and a second mobile phone 20. The first mobile phone 18 and the second mobile phone 20 are capable of communicating wireless with each other while within a service transmission range of the telecommunication system service terminal 12. The second mobile phone 20 includes a message editing module 22 for editing a monitoring message, a wireless communication module 24 for receiving or sending messages, a storage module 26 for storing data, a display module 28 for displaying images, a comparison means 30 for comparing the phone numbers, and a control means 32 for controlling the second mobile phone 20 to execute an operation according to a comparison result of the comparison means 30.

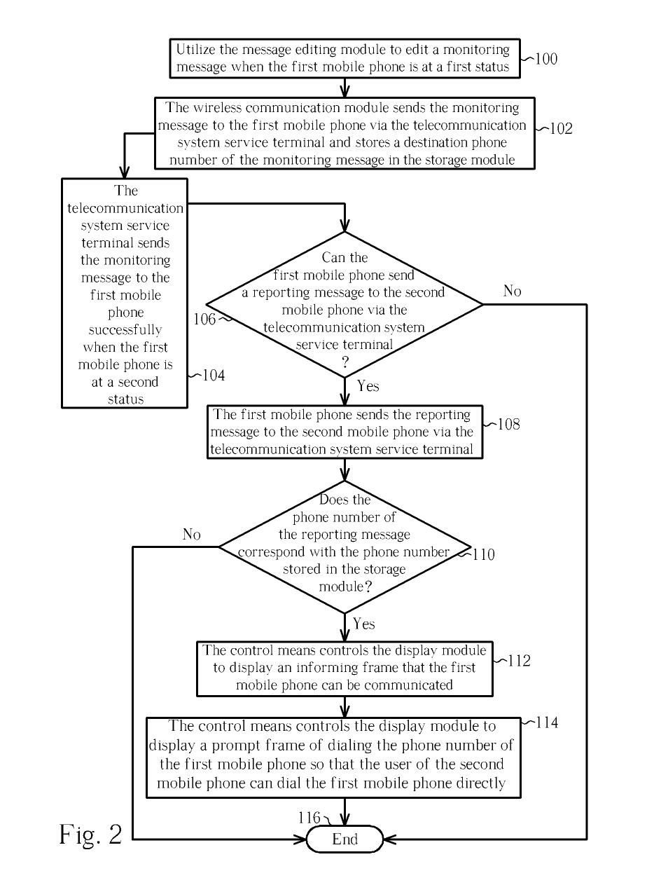

Please refer to FIG. 2. FIG. 2 is a flowchart of reporting a status of the first mobile phone 18 by a message of the present invention. The method includes following steps:

Step 100: Utilize the message editing module 22 of the second mobile phone 20 to edit a monitoring message when the first mobile phone 18 is at a first status (the first mobile phone 18 cannot be communicated).

Step 102: The wireless communication module 24 of the second mobile phone 20 sends the monitoring message to the first mobile phone 18 via the telecommunication system service terminal 12 and stores a destination phone number of the monitoring message (a phone number of the first mobile phone 18) in the storage module 26.

Step 104:The telecommunication system service terminal 12 sends the monitoring message to the first mobile phone 18 successfully when the first mobile phone 18 is at a second status (the first mobile phone 18 can be communicated).

Step 106: Set whether the first mobile phone 18 can send a reporting message to the second mobile phone 20 via the telecommunication system service terminal 12. If yes, go to step 108; if not, go to step 116.

Step 108: The first mobile phone 18 sends the reporting message to the second mobile phone 20 via the telecommunication system service terminal 12.

Step 110: The comparison means 30 of the second mobile phone 20 compares the phone number stored in the storage module 26 in step 102 with a source phone number of the reporting message. If the phone number of the reporting message corresponds with the phone number stored in the storage module 26 in step 102, go to step 112; if not, go to step 116.

Step 112: The control means 32 of the second mobile phone 20 controls the display module 28 to display an informing frame that the first mobile phone 18 can be communicated.

Step 114: The control means 32 of the second mobile phone 20 controls the display module 28 to display a prompt frame of dialing the phone number of the first mobile phone 18 so that the user of the second mobile phone 20 can dial the first mobile phone 18 directly.

Step 116: End.

More detailed descriptions for the steps mentioned above will be provided. Sometimes the first mobile phone 18 cannot be communicated. For example, the first mobile phone 48 is at a power-off status, at a busy line status, or cannot receive signals. The second mobile phone 20 cannot dial the first mobile phone 18 successfully. If the user of the second mobile phone 20 wants to be aware that the first mobile phone 18 can be communicated by a way of reporting the status of the first mobile phone 18 actively, the flowchart shown in FIG. 2 can be proceeded. The user can utilize the message editing module 22 of the second mobile phone 20 to edit the monitoring message. The content of the monitoring message can be a predetermined word, such as “Please call me”, or can be edited by the user. Then the user has to input the destination phone number of the monitoring message, that is, the phone number of the first mobile phone 18. The destination phone number of the monitoring message can be stored in the storage module 26. The wireless communication module 24 of the second mobile phone 20 sends the monitoring message to the first mobile phone 18 via the telecommunication system service terminal 12. When the first mobile phone 18 cannot be communicated, the control center 16 of the telecommunication system service terminal 12 controls the base station 14 to send wireless signals to the first mobile phone 18 continuously until the first mobile phone 18 succeeds in receiving the monitoring message. When the first mobile phone 18 can be communicated, the telecommunication system service terminal 12 succeeds in sending the monitoring message to the first mobile phone 18. The content of the monitoring message is presented on the first mobile phone 18. The user of the first mobile phone 18 can determine whether the communication status of the first mobile phone 18 is reported to the second phone 20, that is, the user of the first mobile phone 18 can determine whether the reporting message is sent to the second phone 20 via the telecommunication system service terminal 12. If the user of the first mobile phone 18 determines the reporting message is not sent to the second phone 20, the second mobile phone 20 cannot be informed that the first mobile phone 18 can be communicated. If the user of the first mobile phone 18 determines the reporting message is sent to the second phone 20, the first mobile phone 18 sends the reporting message to the second phone 20 via the telecommunication system service terminal 12. In addition, the request of reporting the communication status can be ignored on the first mobile phone. That is, the first mobile phone 18 reports the second phone 20 that the first mobile phone 18 can be communicated directly. The monitoring message and the reporting message can include special characters in fields as a special type of messages instead of normal messages.

After the wireless communication module 24 of the second mobile phone 20 receives the reporting message, the comparison means 30 of the second mobile phone 20 compares the phone number stored in the storage module 26 (the destination phone number of the last monitoring message) with the source phone number of the reporting message. If the phone number of the reporting message does not correspond with the phone number stored in the storage module 26, the reporting message is regarded as a normal message and proceeded as the normal message. If the phone number of the reporting message corresponds with the phone number stored in the storage module 26, the receipt of the reporting message is regarded as a reporting action. The control means 32 of the second mobile phone 20 controls the display module 28 to display the informing frame that the first mobile phone 18 can be communicated, such as “the first mobile phone can be communicated”. Then the control means 32 of the second mobile phone 20 also can control the display module 28 to display the prompt frame of dialing the phone number of the first mobile phone 18 so that the user of the second mobile phone 20 can dial the first mobile phone 18 by pressing a dial key directly instead of searching the phone number of the first mobile phone 18 in a telephone directory or a record of dialed phone numbers. The user of the second mobile phone 20 can dial the first mobile phone 18 at the status that the first mobile phone 18 can be communicated.

In addition, the control center 16 of the telecommunication system service terminal 12 can control the base station 14 to send the reporting message to the second mobile phone 20 directly when the first mobile phone 18 can be communicated and the telecommunication system service terminal 12 sends the monitoring message to the first mobile phone 18 successfully. The reporting message includes the phone number of the first mobile phone 18 for the comparison of the comparison means 30. The rest of the features are essentially the same, thus a further description is hereby omitted.

In contrast to the prior art, the present invention provides a method for reporting back a status of a mobile phone by a message and a related mobile phone. It can solve the problem that when the dialed mobile phone does not work, the user has to try dialing the mobile phone again and again until it works. It is convenient that the user can be aware that the dialed mobile phone can be communicated actively by the message. There is no need to change infrastructure of the current mobile phone and the cost does not increase according to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reporting back a status of a mobile phone comprising:
(a) a second mobile phone sending a monitoring message to a first mobile phone via a telecommunication system service terminal when the first mobile phone is at a first status;
(b) sending a reporting message to the second mobile phone according to the monitoring message when the first mobile phone is at a second status;
(c) the second mobile phone comparing data of the monitoring message with data of the reporting message to generate a comparison result after receiving the reporting message; and
(d) the second mobile phone displaying an informing frame according to the comparison result.

2. The method of claim 1 wherein step (a) comprises the second mobile phone sending the monitoring message to the first mobile phone when the first mobile phone is at a power-off status and step (b) comprises sending the reporting message to the second mobile phone when the first mobile phone is at a power-on status.

3. The method of claim 1 wherein step (a) comprises the second mobile phone sending the monitoring message to the first mobile phone when the first mobile phone is at a busy line status and step (b) comprises sending the reporting message to the second mobile phone when the first mobile phone is at an idle status.

4. The method of claim 1 wherein step (a) comprises the second mobile phone sending the monitoring message to the first mobile phone when the first mobile phone cannot receive signals and step (b) comprises sending the reporting message to the second mobile phone when the first mobile phone can receive signals.

5. The method of claim 1 wherein step (b) comprises the telecommunication system service terminal sending the reporting message to the second mobile phone directly when the first mobile phone can be communicated and the telecommunication system service terminal sends the monitoring message to the first mobile phone successfully.

6. The method of claim 1 wherein step (b) comprises the first mobile phone sending the reporting message to the second mobile phone via the telecommunication system service terminal when the first mobile phone can be communicated and the telecommunication system service terminal sends the monitoring message to the first mobile phone successfully.

7. The method of claim 6 further comprising setting whether the first mobile phone can send the reporting message to the second mobile phone via the telecommunication system service terminal.

8. The method of claim 1 further comprising editing the monitoring message with a predetermined word.

9. The method of claim 1 further comprising storing a phone number of the first mobile phone in the second mobile phone when the second mobile phone sends the monitoring message to the first mobile phone via the telecommunication system service terminal.

10. The method of claim 9 wherein step (c) comprises the second mobile phone comparing the phone number of the first mobile phone with a phone number of the reporting message and step (d) comprises the second mobile phone displaying the informing frame when the phone number of the reporting message corresponds with the phone number of the first mobile phone.

11. The method of claim 1 wherein step (d) comprises the second mobile phone displaying the informing frame according to the comparison result for notifying information that the first mobile phone can be communicated.

12. The method of claim 1 further comprising the second mobile phone executing a prompt function of dialing a phone number of the first mobile phone according to the comparison result.

13. A mobile phone comprising:
a message editing module for editing a monitoring message;
a wireless communication module for sending the monitoring message to a first mobile phone when the first mobile phone is at a first status and for receiving a reporting message when the first mobile phone is at a second status;
a storage module for storing a phone number of the first mobile phone when the wireless communication module sends the monitoring message;
a comparison means for comparing the phone number of the first mobile phone stored in the storage module with a phone number of the reporting message to generate a comparison result after the wireless communication module receives the reporting message;
a display module; and a control means for controlling the display module to display an informing frame according to the comparison result.

14. The mobile phone of claim 13 wherein the control means controls the display module to display the informing frame when the phone number of the first mobile phone stored in the storage module corresponds with the phone number of the reporting message.

15. The mobile phone of claim 13 wherein the control means controls the display module to display a prompt frame of dialing the phone number of the first mobile phone according to the comparison result.

16. The mobile phone of claim 13 wherein the first status is a status that the first mobile phone cannot be communicated and the second status is a status that the first mobile phone can be communicated.

17. The mobile phone of claim 16 wherein the first status is a power-off status and the second status is a power-on status.

18. The mobile phone of claim 16 wherein the first status is a busy line status and the second status is an idle status.

19. The mobile phone of claim 16 wherein the first status is a status that the first mobile phone cannot receive signals and the second status is a status that the first mobile phone can receive signals.
